(19) United States
(12) Patent Application Publication
(10) Pub. No.: US 2018/0130100 A1
(43) Pub. Date: May 10, 2018

(54) METHOD, APPARATUS AND COMPUTER PROGRAM FOR EVALUATING PUBLIC TRANSPORTATION FOR REAL ESTATE

(71) Applicant: KOREA INSTITUTE OF SCIENCE AND TECHNOLOGY, Seoul (KR)

(72) Inventors: Suhyun KIM, Seoul (KR); Gyuwon SONG, Seoul (KR)

(73) Assignee: KOREA INSTITUTE OF SCIENCE AND TECHNOLOGY, Seoul (KR)

(21) Appl. No.: 15/802,495

(22) Filed: Nov. 3, 2017

(30) Foreign Application Priority Data
Nov. 4, 2016 (KR) 10-2016-0146460

(51) Int. Cl. G06Q 30/02; G06Q 50/16; G06Q 50/30; G06Q 10/04

(52) U.S. Cl. CPC G06Q 30/0278; G06Q 10/047; G06Q 50/30; G06Q 50/16

(57) ABSTRACT

A method for evaluating public transportation convenience for real estate according to an embodiment includes determining a plurality of target workplaces, receiving input of real estate information, determining a plurality of public transportation routes corresponding to routes from the inputted real estate to each of the plurality of target workplaces, calculating route scores by workplace, for each of the plurality of public transportation routes, reflecting an objective route element and transportation convenience between the inputted real estate and the target workplace, and a preset workplace weight for each target workplace, and evaluating public transportation convenience by summing up the route scores by workplace for each of the plurality of public transportation routes.

### DESCRIPTION OF GOVERNMENT-SPONSORED RESEARCH AND DEVELOPMENT

This research is done in support of R&D project (Project Name: prediction and analysis of social change using gradual machine learning based self-evolving agent simulation, Project Series Number: 1711035814) of Institute for Information & Communications Technology Promotion under the supervision of Ministry of Science, ICT and Future Planning.

### CROSS-REFERENCE TO RELATED APPLICATION

This application claims priority to Korean Patent Application No. 10-2016-0146460, filed Nov. 4, 2016, and all the benefits accruing therefrom under 35 U.S.C. § 119, the contents of which in its entirety are herein incorporated by reference.

### BACKGROUND

### 1. Field

The disclosed technology relates to evaluation of the value of real estate by scoring the movements by public transportation from real estate to major workplaces based on the fact that the value of real estate with convenient accessibility to major workplaces is evaluated higher in evaluating the value of real estate.

### 2. Description of the Related Art

Upon review of the recent geographic distribution trend of companies, a tendency of clustering at particular locations is observed. For example, among 1000 companies located in Seoul, 532 companies are mainly distributed in Jongro, Mapo, Gasan and Gangnam. In another example, among companies located outside of Seoul, in the case of Daejeon province, companies cluster together through the government's intended planning and intervention, and in the case of Seongnam province, companies spontaneously cluster together through self-organization. As companies cluster together (hereinafter, business clustering), floating populations and consumer populations increase, and naturally, commercial spheres and cultural facilities tend to concentrate on business cluster areas, which become thriving downtown districts. Accordingly, convenient accessibility to business cluster areas may be regarded as an important element used to evaluate the value of real estate, and in particular, convenient accessibility to the cluster areas using public transportation is one of important elements to both sellers and buyers.

Currently, evaluation of public transportation convenience for residential real estate simply relies on the distance from areas near public transportation, and in reality, public transportation convenience is set based on how close is it to the public transportation station without any objective index for evaluating the value of public transportation.

### SUMMARY

According to an aspect of the present disclosure, elements used to determine if it is convenient to go to work using public transportation include the distance from real estate occupied to a nearest public transportation station, as well as objective and subjective elements such as the distance and time taken to go to work and congestion by time slot, and through this, there is provided an apparatus, method and computer program for accurately evaluating the public transportation convenience.

A method for evaluating public transportation convenience for real estate which is performed by an apparatus for evaluating public transportation convenience for real estate according to an embodiment may include determining a plurality of target workplaces, receiving input of real estate information, determining a plurality of public transportation routes corresponding to routes from the inputted real estate to each of the plurality of target workplaces, calculating a plurality of route scores by workplace, for each of the plurality of public transportation routes, reflecting an objective route element and transportation convenience between the inputted real estate and the target workplace, and a preset workplace weight for each target workplace, and evaluating public transportation convenience by summing up the route scores by workplace for each of the plurality of public transportation routes.

The method for evaluating public transportation convenience for real estate may additionally include acquiring a public transportation database and a workplace database.

The determining of the public transportation route may include determining public transportation stations within a predetermined search radius from the real estate inputted by an user as a start point, determining public transportation stations within the predetermined search radius from each of the plurality of target workplaces as an end point, and determining each public transportation route from the start point public transportation stations to the end point public transportation stations.

The determining of the plurality of public transportation routes may further include determining walk information from the real estate inputted by the user to the found start point public transportation station and walk information from each of the plurality of target workplaces to each of the found end point public transportation stations.

The calculating of the route score may further include extending the predetermined search radius until at least one public transportation station is found, when no start point public transportation station or end point public transportation station is found within the predetermined search radius.

The determining of the plurality of public transportation routes may include, when there is a plurality of public transportation routes between the inputted real estate and any one of the target workplaces, determining a highest route score from the plurality of public transportation routes between the inputted real estate and the target workplace as a basis of the route score by workplace.

The determining of the plurality of public transportation routes may include determining the public transportation route using at least one of public transportation type, public transportation line, and transfer route.

The determining of the plurality of route scores reflecting the objective route element may include calculating the public transportation route score using at least one of distance of the public transportation route, scheduled interval, simple estimated time, actual estimated time, transfer times, transfer distance, transfer time, and public transportation fare information.

The determining of the plurality of route scores reflecting the transportation convenience may include calculating the route score using at least one of facility condition of public transportation station on the determined public transportation route, congestion in the station, production year information associated with model running on the determined public transportation route, and complexity of transfer route on the determined public transportation route.

In an embodiment, an apparatus for evaluating public transportation convenience for real estate may include an input unit configured to receive input of real estate information, a public transportation route determination unit configured to determine a plurality of public transportation routes corresponding to routes from the inputted real estate to each of a plurality of target workplaces, and a convenience evaluation unit configured to calculate route scores by workplace, for each of the plurality of public transportation routes, reflecting the objective route element and transportation convenience between the inputted real estate and the target workplace and a preset weight for the target workplace, and evaluate public transportation convenience by summing up the route scores by workplace for each of the plurality of public transportation routes.

The apparatus for evaluating public transportation convenience for real estate may further include a database acquisition unit configured to acquire a public transportation database and a workplace database.

The apparatus for evaluating public transportation convenience for real estate may additionally include a database storage unit configured to store a public transportation database and a workplace database.

The route determination unit may be configured to determine public transportation stations within a predetermined search radius from the real estate inputted by a user as a start point, determine public transportation stations within the predetermined search radius from each of the plurality of target workplaces as an end point, and determine each public transportation route from the start point public transportation stations to the end point public transportation stations.

The route determination unit may be further configured to determine walk information from the real estate inputted by the user to the found start point public transportation station and walk information from each of the plurality of target workplaces to each of the found end point public transportation stations.

The route determination unit may be further configured to extend the predetermined search radius until at least one public transportation station is found, when no start point public transportation station or end point public transportation station is found within the predetermined search radius.

The route score calculation unit may be further configured to determine, when there is a plurality of public transportation routes between the inputted real estate and any one of the target workplaces, a highest route score from all route scores for the public transportation routes between the inputted real estate and any one of the target workplaces as a basis of the route score by workplace.

The public transportation route determination unit may be configured to determine the public transportation route using at least one of public transportation type, public transportation line, and transfer route.

The route score generation unit may be configured to calculate the public transportation route score using at least one of distance of the public transportation route, scheduled interval, simple estimated time, actual estimated time, transfer times, transfer zone, transfer distance, transfer time, and public transportation fare information.

The route score calculation unit may be configured to calculate the route score using at least one of facility condition of public transportation station on the determined public transportation route, congestion in the station, information associated with model running on the determined public transportation route, and complexity of transfer route on the determined public transportation route.

In an embodiment, a computer program stored in a recording medium may perform a process in combination with hardware, the process including determining a plurality of target workplaces, receiving input of real estate information, determining a plurality of public transportation routes corresponding to routes from the inputted real estate to each of the plurality of target workplaces, calculating route scores by workplace, for each of the plurality of public transportation routes, reflecting the objective route element and transportation convenience between the inputted real estate and the target workplace and a preset workplace weight for each target workplace, and calculating public transportation convenience scores by summing up the route scores by workplace for each of the plurality of public transportation routes.

According to an aspect of the present disclosure, determination of public transportation convenience simply does not rely on whether real estate is located in areas near public transportation, and the public transportation convenience score of the real estate reflecting an objective element and an element thought to be important by the public transportation user may be calculated. Using this public transportation convenience score, real estate buyers will be provided with more detailed and intuitive information associated with the target real estate.

Accordingly, more objective evaluation index for the real estate is provided to allow potential buyers of the corresponding real estate to estimate accessibility to their current or future workplaces, and on the other hand, allow the real estate owner to sell the real estate more conveniently and profitably using the objective evaluation index, and officers of urban design department to use the object evaluation index to easily find poor transportation regions with low evaluation index and improve the poor transportation regions.

### BRIEF DESCRIPTION OF THE DRAWINGS

FIG. 1 is a block diagram of an apparatus for evaluating public transportation convenience for real estate inputted by a user according to an embodiment.

FIG. 2 is a flowchart of a method for evaluating public transportation convenience for real estate inputted by a user according to an embodiment.

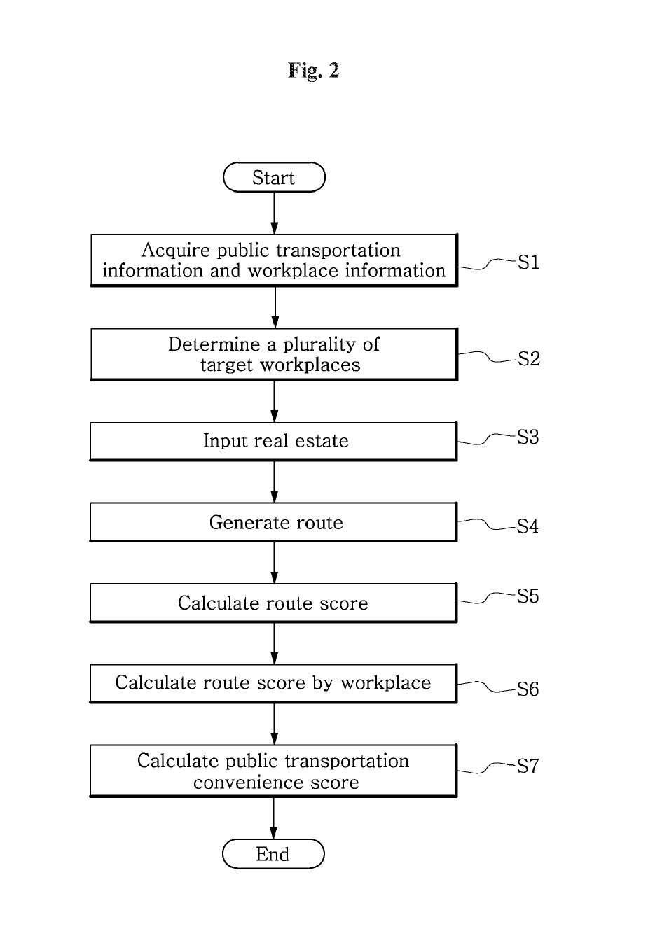

FIG. 3 is a flowchart of a method for evaluating public transportation convenience for real estate inputted by a user according to another embodiment.

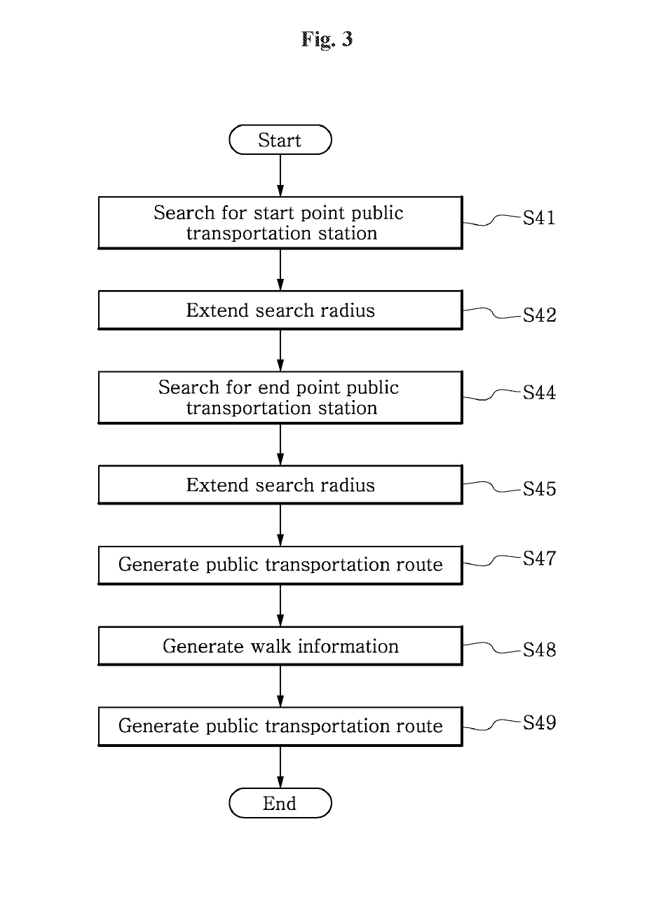

FIG. 4 is a conceptual diagram of a public transportation database of an apparatus for evaluating public transportation convenience for real estate inputted by a user according to an embodiment.

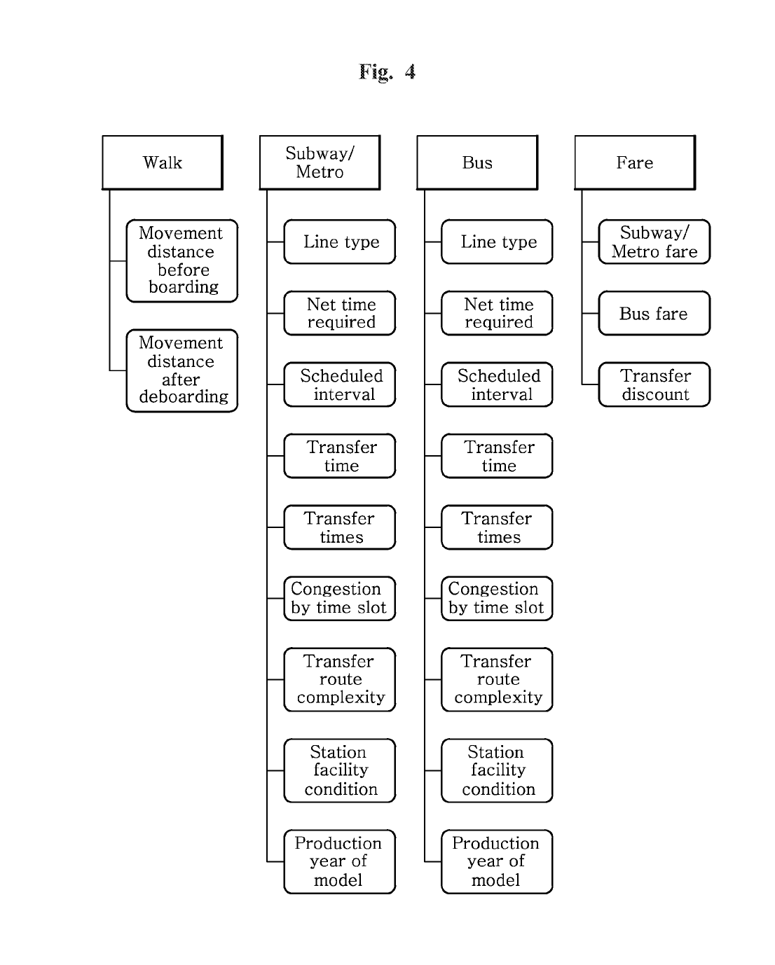

### DETAILED DESCRIPTION

Embodiments will be described with reference to the accompanying drawings. However, the principles disclosed herein may be realized in many different forms and it should be noted that they are not limited to the disclosed embodiments. In the detailed description, a certain detailed description of well-known features and technology may be omitted to avoid unnecessary ambiguity of the features of the embodiments.

In the drawings, the reference numerals in the drawings denote the elements. The shape, size and regions, and the like, of the drawing may be exaggerated for clarity.

The embodiment described herein may have aspects of entirely hardware, partly hardware and partly software, or entirely software. The term “unit”, “module”, “device” or “system” as used herein indicates computer related entity such as hardware, a combination of hardware and software, or software. For example, the unit, module, device or system in the specification may include a process being executed, a processor, an object, an executable, a thread of execution, a program, and/or a computer, but is not limited thereto. For example, both a computer and an application running on the computer may correspond to the unit, module, device or system in the specification.

The term database as used herein refers to a collection of large amounts of structured, unstructured or semi-structured data, and may include building related information and real transaction price information. Here, the structured data is data stored in a fixed field, and includes, for example, relational database and spreadsheet. Furthermore, the unstructured data is data that is not stored in a fixed field, and includes, for example, text document, image, video and audio data. Furthermore, the semi-structured data is data that is not stored in a fixed field but includes metadata or schema, and includes, for example, XML, HTML, and text.

The building related information may include at least one of building register, land register, land use planning certificate, and declared value (land, house, apartment) information, but is not limited thereto.

In the specification, a database system or a database device may have aspects of entirely hardware, or partly hardware and partly software.

The method according to an embodiment of the present disclosure may be embodied in the form of a computer program for performing a series of operations, and the computer program may be recorded in a computer-readable recording medium.

Hereinafter, the embodiments for carrying out the present disclosure will be described in detail with reference to the accompanying drawings.

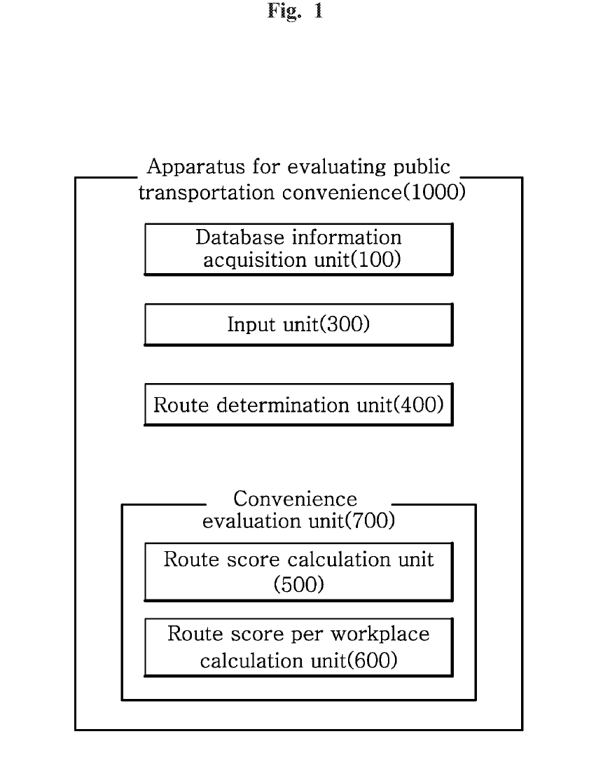

FIG. 1 is a block diagram of an apparatus (or system) for evaluating public transportation convenience for real estate inputted by a user according to an embodiment. Referring to FIG. 1, the apparatus 1000 for evaluating public transportation convenience for real estate inputted by the user may include a database information acquisition unit 100, an input unit 300, a route determination unit 300, and a convenience evaluation unit 700.

The apparatus 1000 may provide the user with convenience score comprehensively representing the access convenience from the target real estate inputted by the user to a plurality of preset target workplaces. In an embodiment, the apparatus 1000 may be a computing device that can use external database information such as cloud computing.

The apparatus 1000 may be all types of terminals that can connect to an external database server to make data communications as per the user's request. For example, the apparatus 1000 may be a terminal (e.g., a PC, a laptop computer, etc.) that can connect to a data network (e.g., an Internet) wiredly/wirelessly.

In another embodiment, the apparatus 1000 may further include a database information storage unit therein to store information of a public transportation database and a workplace database associated with the plurality of target workplaces. When the apparatus 1000 includes the database information storage unit therein as in the embodiment, the stored database information may be acquired from the external database, and may be acquired from the user's input (S1).

The public transportation with which the information included in the public transportation database is associated generally includes all transportation facilities and means that provide transportation services available to the public, such as bus (express bus, direct bus, intracity bus, in-town bus, etc.), subway, light rail, and train (express train, Saemaeul, Mugunghwa, etc.). In an embodiment, in the case of evaluation of public transportation score for the target real estate near Seoul, the public transportation database may include usage status information by Seoul public transportation means, Seoul public transportation transfer route information, statistical information associated with Seoul transportation means used to commute to work/school, Seoul subway neighborhood transfer bus information, ridership information by Seoul subway line/station, Seoul subway shortest route information, Seoul subway congestion statistical information, subway timetable information by Seoul subway station, ridership information by Seoul bus line/station, Seoul bus line information, and Seoul intracity bus station status statistical information.

The workplace database includes fragmentary data used to simply determine a route such as business name and business location, as well as information used to determine major companies having high preference to ordinary people from a great deal of companies, and information used as criteria that may be considered as advantages compensating for the downside of workplace with a long route distance and much time taken to travel by public transportation. This information includes number of employees, annual sales, business size, and corporate tax amount included in materials such as ‘National Business Survey’ from Bureau of Statistics, ‘List of companies traded on stock exchange’ from Business disclosure channel, and ‘Corporate Management Analysis’ from Bank of Korea.

The apparatus 1000 may include a target workplace determination unit to determine a plurality of target workplaces. Here, the target workplace is used to determine public transportation convenience score for the real estate using the information of the workplace database. The target workplace determination unit may determine the target workplace used to evaluate public transportation convenience from many workplaces based on the information in the workplace database (S2). In an embodiment, the criteria for determining the target workplace may include many criteria affecting the determination of convenience score as described below. In another embodiment, simply pre-input or preset workplaces may be available without separate determination criteria, such as, for example, input of ‘Korean 1000 companies’ list announced by Korea Chamber of Commerce & Industry.

The input unit 300 receives the user's input of information associated with the target real estate for which public transportation convenience is evaluated (S3). The real estate information inputted by the user may be an address. However, the inputted real estate information is not limited to the address, and may include at least one of basement or no basement, floor, area, structure, gross area, floor area ratio, construction year, number of households, number of parking space per household, number of elevators, and officially assessed individual land price. Examples of the inputted real estate information are for illustration only, and are not limited thereto.

The step of acquiring public transportation information and workplace information (S1), the step of determining a plurality of target workplaces (S2), and the step of receiving input of real estate information (S3) may be performed in a different order. For example, in case that inputting information associated with the real estate desired by the user functions as a start command of public transportation convenience evaluation for the real estate, the apparatus 1000 may perform the step of inputting information associated with the real estate desired by the user (S3) first, and then, may perform the step of acquiring information necessary to determine a route from the database (S1) and the subsequent steps.

Based on the acquired database information and the inputted real estate information, the route determination unit 400 may determine each public transportation route from the inputted real estate to the plurality of target workplaces (S4).

In an embodiment, the step of calculating, by the score calculation unit, each public transportation route score to the plurality of target workplaces (S4) may include (i) searching for public transportation station as a start point of route (S41), (ii) searching for public transportation station as an end point of route (S44), and (iii) determining route from each found start public transportation station to each found destination public transportation station (S48).

At S41, the step of searching for public transportation station as the start point of route includes determining all public transportation stations located within a predetermined distance (hereinafter, a search radius) preset in the apparatus 1000 from the location of the real estate inputted by the user (i.e., the target real estate) as the start point public transportation station. For example, when the search radius is set to 100 m, all subway stations and in-town bus and intracity bus stations located within the radius of 100 m from the real estate inputted by the user may be the start point of public transportation route.

Additionally, when no public transportation station is found within the search radius, the step of extending the search radius until at least one public transportation station is found (S42) may be further included.

Additionally, to improve the efficiency of public transportation route search, the step of setting a critical value for the start point public transportation station may be further included, and when the number of start point public transportation stations found within the predetermined search radius is larger than the preset critical value, the step of reducing the search radius may be included.

The step of searching for public transportation station as the end point of route also includes searching for public transportation station within the search radius from the location of the determined target workplace (S44). In the same way as S42, when no public transportation station as the end point is found within the search radius from the selected target workplace, the step of extending the search radius until at least one public transportation station is found (S45) may be additionally included.

Additionally, to improve the efficiency of public transportation route search, the step of setting a critical value for the end point public transportation station may be further included, and when the number of end point public transportation stations within the predetermined search radius is larger than the preset critical value, the step of reducing the search radius may be included.

After S44 or S45, each public transportation route from the start point public transportation station to the end point public transportation station for the plurality of target workplaces is determined (S47). In an embodiment, public transportation database information used at S47 to determine segment information of the public transportation route may include public transportation related information such as subway/metro line type, bus line type, transfer zone and transfer times in the public transportation database, and business location information of the target workplace in the workplace database.

More specifically, the public transportation database information used may include bus network information, bus station information and respective bus information, subway network information, subway station information, respective subway information, and transfer information. Here, the bus network information includes bus link information, travel time by link, link direction, link type, road type of link, area code, and line type information by link, the bus station information includes station attribute (center lane, complex park-and-ride lot, etc.), bus number available for transfer at station/subway exit information, station code and station name, and the respective bus information includes bus number, first/last station name, schedule time and first/last time information. The subway network information includes line code, subway line information and travel time by direction, the subway station information includes station attribute (transfer station, general station, last station, exit, etc.), and the respective subway information includes additional information such as platform location, the time (or distance) from subway station to each subway exit, meeting point, the side on which the door open, bathroom or no bathroom and its location, and park and ride lot or no park and ride lot. Furthermore, the transfer information includes bus information available for transfer from subway station (station location, distance to station, bus number, etc.), subway station information available for transfer from bus station, and transfer distance/time information. Examples of the public transportation database information used are for illustration purposes only, and the present disclosure is not limited thereto.

Additionally, based on the determined public transportation route, the step of determining walk information from the real estate inputted by the user to the public transportation station as the start point, and walk information from the public transportation station as the end point to the determined target workplace (S48) may be included. The walk information includes movement route by walk, required time, and estimated number of steps. A method for determining walk information from the real estate inputted by the user to the public transportation station as the start point makes calculations on the basis of mean adult walking speed of 4 km/h.

In another embodiment, the step of determining walk information may be divided into the step of determining walk information from the inputted real estate to the public transportation station as the start point and the step of determining walk information from the end point public transportation station to the target workplace. For example, the route determination unit 400 may perform the step of determining walk information from the inputted real estate to the public transportation station as the start point after S41 and S42, and the step of determining walk information from the end point public transportation station to the target workplace after S44 and S45.

A route score calculation unit 500 may calculate route score reflecting the objective route element and the transportation convenience for the public transportation route determined in the step S4 and the weight by workplace, based on the determined public transportation routes to the plurality of target workplaces (S5).

Route score=f_{h,oi}(public transportation route,objective route element,transportation convenience) [Equation 1]

In the Equation 1, h is the location of the real estate inputted by the user, O is the location of the target workplace, and i is the number of target workplaces and is a natural number greater than or equal to 1.

Based on transportation convenience as well as the objective route element for the public transportation route determined in the step S4, the route score for the real estate inputted by the user is calculated (S5). Here, the object route element includes the distance element of public transportation route including the movement distance of public transportation such as bus and subway and transfer zone distance to move for transfer between public transportation, and the other objective route element including objective elements except the element associated with public transportation movement distance, for example, simple estimated time, actual estimated time, scheduled interval, the time taken to transfer (hereinafter, transfer time), transfer times, and public transportation fare information. The simple estimated time refers to a value based on a value obtained by simply dividing the route distance by the average public transportation speed and average dwell time. In contrast, the actual estimated time is a result value, taking the traffic flow by time slot into account. For example, in the case of rush hours, generally, because public transportation moves at low speed and large numbers of passengers board and deboard, the dwell time increases, and thus the actual estimated time at rush hours will be determined to be longer than the simple estimated time.

The transportation convenience is a subjectively important element affecting public transportation users, and may include congestion by time slot at public transportation station on the determined public transportation route, complexity of transfer route, facility condition of the station, or the production year of public transportation means mainly running.

For example, heating in winter and air-conditioning in summer is one of important considerations to customers using public transportation. In general, new model subway has better heating and air-conditioning equipment than old model subway. Accordingly, in the determined public transportation routes, route score of a route along which new model subway mainly runs may be higher than route score of a route along which old model subway mainly runs. In another example, route score of a route including a simple transfer route (for example, going down only one floor) may be higher than route score of a route including a complex transfer route (for example, going down three floors).

Additionally, in case that a plurality of start point public transportation stations is found and a plurality of public transportation routes is determined at S4, when each route score is calculated based on this, a plurality of route scores is calculated. To improve the efficiency of the method and apparatus for evaluating public transportation convenience, the highest score from the plurality of route scores may be determined as route score on which evaluation of public transportation convenience is based.

Based on the calculated route score, the route score per workplace calculation unit 600 calculates route score by workplace reflecting the weight by workplace for the target workplace (S6). The route score per workplace calculation unit 600 determines the weight by workplace using at least one information used to determine whether the job is good or bad, acquired from the workplace database, such as business name, brand power, organization type, business type, number of employees, annual sales, preference, listed or unlisted on stock exchange, the term of service, or annual average wage. Based on the highest route score and the weight by workplace, the route score by workplace may be expressed as below.

Route score by workplace=wᵢ(f_{h,oi}(public transportation route,objective route element,transportation convenience)) [Equation 2]

In the Equation 2, W is the weight by workplace for each target workplace, and i is a natural number greater than or equal to 1.

The route score per workplace calculation unit 600 may calculate route score by workplace based on the weight by workplace (S6). The weight by workplace may include at least one of business name, brand power, organization type, business type, number of employees, annual sales, preference, listed or unlisted on stock exchange, and the term of service and annual average wage, but is not limited thereto.

For example, even though the route scores are the same for different target workplaces, when the weight by workplace is different for each target workplace, job score of a target workplace with a higher weight by workplace is higher than job score of a target workplace with a low weight by workplace.

After the route score by workplace is calculated for each of the plurality of target workplace (S6), the public transportation convenience for the inputted real estate may be evaluated by summing up the route scores (S7). In an embodiment, the convenience evaluation unit 700 may calculate the sum score of the route scores by workplace as the public transportation convenience score, thereby providing the user with means to evaluate the public transportation convenience of the real estate more intuitively.

Public transportation convenience score=Σ₁₌ₗⁿwᵢ(f_{h,oi}(public transportation route,objective route element,transportation convenience)) [Equation 3]

Based on the calculated public transportation convenience score, the evaluation method may visually provide the convenience evaluation results to the user, or transmit the evaluation results to another device or system. To this end, the evaluation the apparatus 1000 may further include an output unit or a transmission unit.

Accordingly, determination of public transportation convenience simply does not rely on whether the real estate is located in areas near public transportation, and the public transportation convenience score of the real estate reflecting the objective element and the subjective element thought to be important by the public transportation user may be calculated. Further, using this public transportation convenience score, more detailed and intuitive information may be provided to real estate buyers.

A method for determining the public transportation convenience score for the real estate inputted by the user as described above may be implemented as an application or in the form of program command that is executed through various computer components and may be recorded in computer-readable recording media. The computer-readable recording media may include program commands, data files and data structures alone or in combination. The program command recorded in the computer-readable recording media may be specially designed and configured for the present disclosure, and may be known and available to those having ordinary skill in the field of computer software.

Examples of the computer-readable recording media include hardware devices specially designed to store and execute program commands, such as magnetic media such as hard disk, floppy disk and magnetic tape, optical media such as CD-ROM and DVD, magneto-optical media such as floptical disk, and ROM, RAM and flash memory. Examples of the program command include machine code generated by a compiler as well as high-level language code that can be executed by a computer using an interpreter. The hardware device may be configured to act as one or more software modules to perform the operation according to the present disclosure, or vice versa.

While the preferred embodiments have been hereinabove illustrated and described, the disclosure is not limited to the particular embodiments described above, and it should be noted that various modifications may be made to the embodiments by those having ordinary skill in the technical field to which the disclosure belongs without departing from the claimed subject matter of the appended claims, and these modifications should not be understood separately from the technical spirit or scope of the disclosure.

Furthermore, both a product invention and a method invention are described in the disclosure, and the description of the two inventions may be complementarily applied when needed.

1. A method for evaluating public transportation convenience for real estate, which is performed by an apparatus for evaluating public transportation convenience for real estate, the method comprising:
determining a plurality of target workplaces;
receiving input of real estate information;
determining a plurality of public transportation routes corresponding to routes from the inputted real estate to each of the plurality of target workplaces;
calculating a plurality of route scores by workplace, for each of the plurality of public transportation routes, reflecting an objective route element and a transportation convenience between the inputted real estate and the target workplace, and a preset workplace weight for each of the plurality of target workplaces; and
evaluating public transportation convenience for the inputted real estate by summing up the route scores by workplace for each of the plurality of public transportation routes.

2. The method for evaluating public transportation convenience for real estate inputted by a user according to claim 1, wherein additionally comprises acquiring a public transportation database and a workplace database.

3. The method for evaluating public transportation convenience for real estate according to claim 1, wherein the determining of the public transportation route comprises:
determining public transportation stations within a predetermined search radius from the real estate inputted by the user as a start point;
determining public transportation stations within the predetermined search radius from each of the plurality of target workplaces as an end point; and
determining each public transportation route from the start point public transportation stations to the end point public transportation stations.

4. The method for evaluating public transportation convenience for real estate according to claim 3, wherein the determining of the plurality of public transportation routes further comprises:
determining walk information from the real estate inputted by the user to the found start point public transportation station and walk information from each of the plurality of target workplaces to each of the found end point public transportation stations.

5. The method for evaluating public transportation convenience for real estate according to claim 3, wherein the determining of the plurality of public transportation routes further comprises:
extending the predetermined search radius until at least one public transportation station is found, when no start point public transportation station or end point public transportation station is found within the predetermined search radius.

6. The method for evaluating public transportation convenience for real estate according to claim 3, wherein the calculating of the route score further comprises:
when there is a plurality of public transportation routes between the inputted real estate and any one of the target workplaces, determining a highest route score from all route scores for the public transportation routes between the inputted real estate and any one of the target workplaces as a basis of the route score by workplace.

7. The method for evaluating public transportation convenience for real estate according to claim 1, wherein the determining of the plurality of public transportation routes comprises:
determining the public transportation route using at least one of public transportation type, public transportation line, and transfer route.

8. The method for evaluating public transportation convenience for real estate according to claim 7, wherein the determining of the plurality of route scores reflecting the objective route element comprises:
calculating the public transportation route score using at least one of distance of the public transportation route, scheduled interval, simple estimated time, actual estimated time, transfer times, transfer distance, transfer time, and public transportation fare information.

9. The method for evaluating public transportation convenience for real estate according to claim 8, wherein the determining of the plurality of route scores reflecting the transportation convenience comprises:
calculating the route score using at least one of facility condition of public transportation station on the determined public transportation route, congestion in the station, production year information associated with model running on the determined public transportation route, and complexity of transfer route on the determined public transportation route.

10. An apparatus for evaluating public transportation convenience for real estate, comprising:
an input unit configured to receive input of real estate information;
a public transportation route determination unit configured to determine a plurality of public transportation routes corresponding to routes from the inputted real estate to each of a plurality of target workplaces; and
a public transportation convenience evaluation unit configured to calculate route scores by workplace, for each of the plurality of public transportation routes, reflecting an objective route element and transportation convenience between the inputted real estate and the target workplace and a preset weight by workplace for the target workplace, and calculate public transportation convenience score by summing up the route scores by workplace for each of the plurality of public transportation routes.

11. The apparatus for evaluating public transportation convenience for real estate according to claim 10, wherein further comprises a database information acquisition unit configured to acquire public transportation database information and workplace database information.

12. The apparatus for evaluating public transportation convenience for real estate according to claim 10, wherein further comprises a database information storage unit configured to store public transportation database information and workplace database information.

13. The apparatus for evaluating public transportation convenience for real estate according to claim 10, wherein the route determination unit is configured to determine public transportation stations within a predetermined search radius from the real estate inputted by a user as a start point, determine public transportation stations within the predetermined search radius from each of the plurality of target workplaces as an end point, and determine each public transportation route from the start point public transportation stations to the end point public transportation stations.

14. The apparatus for evaluating public transportation convenience for real estate according to claim 13, wherein the route determination unit is further configured to determine walk information from the real estate inputted by the user to the found start point public transportation station and walk information from each of the plurality of target workplaces to each of the found end point public transportation stations.

15. The apparatus for evaluating public transportation convenience for real estate according to claim 13, wherein the route determination unit is further configured to extend the predetermined search radius until at least one public transportation station is found, when no start point public transportation station or end point public transportation station is found within the predetermined search radius.

16. The apparatus for evaluating public transportation convenience for real estate according to claim 13, wherein the route score calculation unit is further configured to determine, when there is a plurality of public transportation routes between the inputted real estate and any one of the target workplaces, a highest route score from all route scores for the public transportation routes between the inputted real estate and any one of the target workplaces as a basis of the route score by workplace.

17. The apparatus for evaluating public transportation convenience for real estate according to claim 10, wherein the public transportation route determination unit is configured to determine the public transportation route using at least one of public transportation type, public transportation line, and transfer route.

18. The apparatus for evaluating public transportation convenience for real estate according to claim 17, wherein the route score calculation unit is configured to calculate the public transportation route score using at least one of distance of the public transportation route, scheduled interval, simple estimated time, actual estimated time, transfer times, transfer distance, transfer time, and public transportation fare information.

19. The apparatus for evaluating public transportation convenience for real estate according to claim 17, wherein the route score calculation unit is configured to calculate the route score using at least one of facility condition of public transportation station on the determined public transportation route, congestion in the station, production year information associated with model running on the determined public transportation route, and complexity of transfer route on the determined public transportation route.

20. A computer program stored in a recording medium to perform a process in combination with hardware, the process comprising:
determining a plurality of target workplaces;
receiving input of real estate information;
determining a plurality of public transportation routes corresponding to routes from the inputted real estate to each of the plurality of target workplaces;
calculating route scores by workplace, for each of the plurality of public transportation routes, reflecting an objective route element and transportation convenience between the inputted real estate and the target workplace and a preset workplace weight for each target workplace; and
calculating public transportation convenience score by summing up the route scores by workplace for each of the plurality of public transportation routes.
